(19) United States
(12) Patent Application Publication
(10) Pub. No.: US 2003/0157345 A1
(43) Pub. Date: Aug. 21, 2003

(54) Plasma deposited barrier coating comprising an interface layer, method of obtaining same and container coated therewith

(76) Inventors: Nasser Beldi, Le Havre Cedex (FR); Eric Adriansens, Le Havre Cedex (FR)

Correspondence Address: SUGHRUE MION, PLLC, 2100 PENNSYLVANIA AVENUE, N.W., WASHINGTON, DC, 20037, US

(21) Appl. No.: 10/333,720

(22) PCT Filed: Jul. 20, 2001
(86) PCT No.: PCT/FR01/02368

(30) Foreign Application Priority Data
Aug. 1, 2000 (FR) 00/10102

(51) Int. Cl. B32B 9/04

(52) U.S. Cl. 428/447

(57) ABSTRACT

The invention concerns in particular a method using a low pressure plasma for depositing a barrier coating on a substrate to be treated, wherein the plasma is obtained by partial ionisation, under the action of an electromagnetic field, of a reaction fluid injected under low pressure in a treating zone. The method is characterised in that it comprises at least a step which consists in depositing on the substrate an interface layer which is obtained by bringing to plasma state a mixture comprising at least an organosilicon compound and a nitrogenous compound, and a step which consists in depositing, on the interface layer, a barrier layer, essentially consisting of a silicon oxide of formula SiOx.

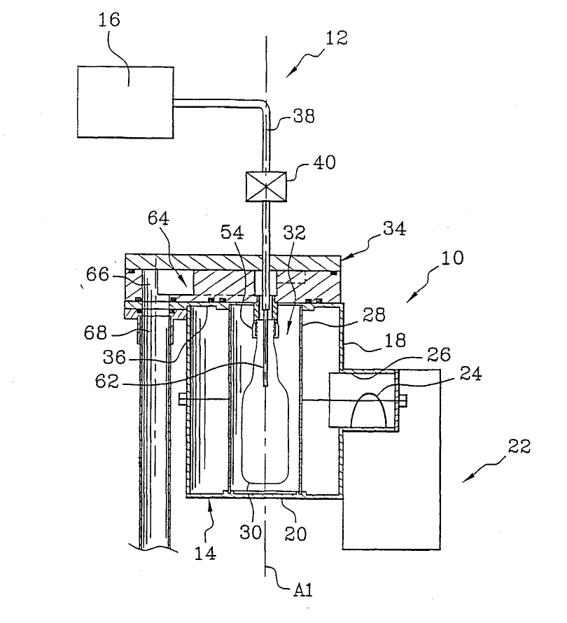

The invention concerns thin film barrier coatings deposited by means of low-pressure plasma. In order to obtain such coatings, a reactive fluid is injected under low pressure into a processing area. This fluid, when it is brought up to the pressures used, is generally gaseous. In the treatment area, an electromagnetic field is established to change this fluid over to the plasma state, that is, to cause at least a partial ionization thereof. The particles issuing from this ionization mechanism can then be deposited on the walls of the object that is placed in the treatment area.

Deposits by low pressure plasmas, also called cold plasmas, allow thin films to be deposited on temperature-sensitive objects made of plastic while ensuring a good physical-chemical adhesion of the coating deposited on the object.

Such deposition technology is used in various applications. One of these applications concerns the deposition of functional coatings on films or containers, particularly for the purpose of decreasing their permeability to gases such as oxygen and carbon dioxide.

In particular, it has recently been determined that such a technology can be used to coat plastic bottles with a barrier material, which bottles are used to package products that are sensitive to oxygen, such as beer and fruit juices, or carbonated products such as sodas.

Document WO99/49991 describes a device that allows the internal or external face of a plastic bottle to be covered with a barrier coating.

Document U.S. Pat. No. 4,830,873 describes a coating that is used for its abrasion resistance properties. This coating is a generic formula silicon oxide SiOx in which x is between 1.5 and 2. To improve the adhesion of the SiOx on the plastic substrate, this document proposes depositing a layer of an SiOxCyHz compound obtained by converting to plasma an organosiloxane in the absence of oxygen, then progressively varying the composition of this adhesion layer while progressively decreasing the quantity of carbon and hydrogen, and while progressively incorporating oxygen into the mixture converted to the plasma state.

Tests have shown that this adhesion layer was also useful when the coating containing SiOx was used to reduce the permeability of a polymer substrate. However, the results obtained with the SiOxCyHz adhesion layer, while better than those obtained with a mono-layer coating of SiOx, are still not as good as those obtained with other gas-barrier coatings such as deposits of hydrogenated amorphous carbon. Indeed, it should be noted that in the U.S. Pat. No. 4,830,873 document, the function of the coating was anti-abrasive. Consequently, the mechanism of diffusion of a gas through the different layers of the coating was not taken into account.

The purpose of the invention, therefore, is to propose a new type of coating optimized to obtain a very high level of barrier properties.

To that end, the invention proposes firstly a method using a low pressure plasma to deposit a barrier coating on a substrate to be treated, of the type in which the plasma is obtained by partial ionization, under the action of an electromagnetic field, of a reactive fluid injected under low pressure into the treatment area, characterized in that it comprises at least one step consisting of depositing on the substrate an interface layer obtained by converting to plasma a mixture that includes at least an organosilicon compound and a nitrogen compound, and a step consisting of depositing on the interface layer a barrier layer composed essentially of a silicon oxide with the formula SiOx.

According to other characteristics of this method according to the invention:

the nitrogen compound is nitrogen gas;

the mixture used to deposit the interface layer also has a rare gas that is used as a carrier gas to cause the evaporation of the organosilicon compound;

the nitrogen is used as carrier gas to cause the evaporation of the organosilicon compound;

the thickness of the interface layer is between 2 and 10 nanometers;

the barrier layer is obtained by low-pressure plasma deposition of an organosilicon compound in the presence of an excess of oxygen;

the organosilicon compound is an organosiloxane;

the barrier layer has a thickness of between 8 and 20 nanometers;

the steps are continuously linked so that, in the processing area, the reactive fluid remains in the plasma state during the transition between the two steps;

the method includes a third step during which the barrier layer is covered with a protective layer of hydrogenated amorphous carbon;

the protective layer has a thickness of less than 10 nanometers;

the protective layer is obtained by low-pressure plasma deposition of a hydrocarbonated compound;

the substrate is composed of a polymer material; and

the method is implemented to deposit a barrier coating on the inner face of a container made of polymer material.

The invention also concerns a barrier coating deposited on a substrate by low pressure plasma, characterized in that it comprises a barrier layer, composed essentially of a silicon oxide with the formula SiOx, and in that, between the substrate and the barrier layer, the coating includes an interface layer that is composed essentially of silicon, carbon, oxygen, nitrogen, and hydrogen.

According to other characteristics of the coating according to the invention:

the interface layer is obtained by converting to the plasma state a mixture comprising at least an organosilicon compound and a nitrogen compound;

the nitrogen compound is nitrogen gas;

the thickness of the interface layer is between 2 and 10 nanometers;

the barrier layer is obtained by low-pressure plasma deposition of an organosilicon compound in the presence of an excess of oxygen;

the organosilicon compound is an organosiloxane;

the barrier layer has a thickness of between 8 and 20 nanometers;

the barrier layer is covered with a protective layer of hydrogenated amorphous carbon;

the barrier layer has a thickness of less than 10 nanometers;

the barrier layer is obtained by low-pressure plasma deposition of a hydrocarbonated compound;

the coating is deposited on a substrate made of a polymer material.

The invention also concerns a container made of polymer material, characterized in that it is covered on at least one of its faces with a barrier coating of the type described above. This container is coated with a barrier coating on its inner face, for example, and it can be a bottle made of polyethylene terephtalate.

Other characteristics and advantages of the invention will appear from the following detailed description, with reference to the sole FIGURE.

Illustrated in the FIGURE is a diagrammatic view in axial cross section of one form of embodiment of a processing station 10 enabling the implementation of a method according to the features of the invention. The invention will be described here within the scope of the treatment of containers made of plastic material. More specifically, a method and a device will be described that allow a barrier coating to be deposited on the inner face of a plastic bottle.

The station 10 can, for example, make up part of a rotary machine including a carrousel driven in continuous rotational movement around a vertical axis.

The processing station 10 includes an external enclosure 14 that is made of an electrically conductive material such as metal, and which is formed from a tubular cylindrical wall 18 with a vertical axis A1. The enclosure 14 is closed at its lower end by a bottom wall 20.

Outside the enclosure 14, attached thereto, there is a housing 22 that includes the means (not shown) for creating inside the enclosure 14 an electromagnetic field capable of generating a plasma. In this instance, it can involve means suitable for generating an electromagnetic radiation in the UHF range, that is, in the microwave range. In this case, the housing 22 can therefore enclose a magnetron the antenna 24 of which enters into a wave-guide 26. For example, this wave-guide 26 is a tunnel of rectangular cross section that extends along a radius of the axis A1 and opens directly into the enclosure 14 through the sidewall 18. However, the invention could also be implemented within the scope of a device furnished with a source of radio-frequency type radiation, and/or the source could also be arranged differently, for example at the lower axial end of the enclosure 14.

Inside the enclosure 14 there is a tube 28 with axis A1 which is made of a material that is transparent to the electromagnetic waves introduced into the enclosure 14 via the wave-guide 26. For example, the tube 28 can be made of quartz. This tube 28 is intended to receive a container 30 to be treated. Its inside diameter must therefore be adapted to the diameter of the container. It must also delimit a cavity 32 in which a partial vacuum will be created after the container is inside the enclosure.

As can be seen in the FIGURE, the enclosure 14 is partially closed at its upper end by an upper wall 36 that has a central opening with a diameter appreciably equal to the diameter of the tube 28, so that the tube 28 is completely open upward to allow the container 30 to be placed in the cavity 32. On the contrary, it can be seen that the lower metal wall 20, to which the lower end of the tube 28 is sealably attached, forms the bottom of the cavity 32.

To close the enclosure 14 and the cavity 32, the treatment station 10 has a cover 34 that is axially movable between an upper position (not shown) and a lower closed position illustrated in the sole FIGURE. In the upper position, the cover is sufficiently open to allow the container 30 to be introduced into the cavity 32.

In the closed position, the cover 34 rests sealably against the upper face of the upper wall 36 of the enclosure 14.

According to one variation of the invention, the barrier layer can be covered by a protective layer of hydrogenated amorphous carbon deposited by low-pressure plasma.

From document WO99/49991 it is known that hydrogenated amorphous carbon can be used as a barrier layer. However, in order to obtain good barrier values, it is necessary to deposit a thickness on the order of 80 to 200 nanometers, because thicknesses of more than this produce a not negligible yellowish coloration of the carbon layer.

Within the scope of the present invention, the deposited carbon layer has a thickness that is preferably less than 20 nanometers. At this level of thickness, the contribution of this additional layer in terms of barrier to gases is not an influencing factor, even if this contribution exists.

The principal benefit of adding a hydrogenated amorphous carbon layer of such reduced thickness is in the fact that it has been determined that the SiOx layer protected in this way has better resistance to the different deformations of the plastic substrate. Thus, a plastic bottle full of carbonated liquid such as soda or beer is subject to an internal pressure of several bars, which in the case of the lightest bottles can lead to creep in the plastic material resulting in a slight increase in the bottle's volume. It has been noted that dense materials such as SiOx deposited by low-pressure plasma have a much lower elasticity than that of the plastic substrate. Also, in spite of the very strong adhesion to the substrate, the deformation of the substrate leads to the appearance of micro-cracks in the coating, which weakens the barrier properties.

However, it has been noted that by applying a layer of hydrogenated amorphous carbon as a protective layer, the degradation of the barrier properties of the coating thus constituted is much less when the substrate is deformed.

By way of example, this layer of hydrogenated amorphous carbon can be produced by introducing acetylene gas into the processing area at a flow rate of about 60 sccm for about 0.2 second. The protective layer thus deposited is thin enough that its coloration is hardly discernible to the naked eye, while significantly increasing the overall strength of the coating.

In a particularly advantageous way, the cover 34 does not function solely to sealably close the cavity 32. Indeed, it has additional parts.

Firstly, the cover 34 has means to support the container. In the illustrated example, the containers to be treated are bottles made of thermoplastic material, such as polyethylene terephtalate (PET). These bottles have a small collar that extends radially out from the base of their neck in such a way that they can be grasped by a gripper cup 54 that engages or snaps around the neck, preferably under said collar. Once it is picked up by the gripper cup 54, the bottle 30 is pressed upward against the support surface of the gripper cup 54. Preferably, this support surface is impermeable so that when the cover is in the closed position, the interior space of the cavity 32 is separated by the wall of the container into two parts: the interior and the exterior of the container.

This arrangement allows only one of the two surfaces (inner or outer) of the wall of the container to be treated. In the example illustrated, only the inner surface of the container's wall is intended to be treated.

This internal treatment requires that both the pressure and the composition of the gases present inside the container be controllable. To accomplish this, the interior of the container must be connected with a vacuum source and with a reactive fluid feed device 12. Said feed device includes a source of reactive fluid 16 connected by a tube 38 to an injector 62 that is arranged along axis A1 and which is movable with reference to the cover 34 between a retracted position (not shown) and a lowered position in which the injector 62 is inserted into the container 30 through the cover 34. A control valve 40 is interposed in the tube 38 between the fluid source 16 and the injector 62. The injector 62 can be a tube with porous wall which makes it possible to optimize the distribution of the injection of reactive fluid in the processing area.

In order for the gas injected by the injector 62 to be ionized and to form a plasma under the effect of the electromagnetic field created in the enclosure, the pressure in the container must be lower than the atmospheric pressure, for example on the order of 10⁻⁴ bar. To connect the interior of the container with a vacuum source (such as a pump), the cover 34 includes an internal channel 64 a main termination of which opens into the inner face of the cover, more specifically at the center of the support surface against which the neck of the bottle 30 is pressed.

It will be noted that in the proposed mode of embodiment, the support surface is not formed directly on the lower face of the cover, but rather on a lower annular surface of the gripper cup 54 which is attached beneath the cover 34. Thus, when the upper end of the neck of the container is pressed against the support surface, the opening of the container 30, which is delimited by this upper end, completely encloses the orifice through which the main termination opens into the lower face of the cover 34.

In the illustrated example, the internal channel 64 of the cover 24 includes an interface end 66 and the vacuum system of the machine includes a fixed end 68 that is arranged so that both ends 66, 68 face each other when the cover is in the closed position.

The illustrated machine is designed to treat the inner surface of containers that are made of a relatively deformable material. Such containers could not withstand an overpressure on the order of 1 bar between the outside and the inside of the bottle. Thus, in order to obtain a pressure inside the bottle of about 10⁻⁴ bar without deforming the bottle, the part of the cavity 32 outside the bottle must also be at least partially depressurized. Also, the internal channel 64 of the cover 34 includes, in addition to the main termination, an auxiliary termination (not shown) which also opens through the lower face of the cover, but radially outside the annular support surface against which the neck of the container is pressed.

Thus, the same pumping means simultaneously create the vacuum inside and outside the container.

In order to limit the volume of pumping, and to prevent the appearance of a unusable plasma outside the bottle, it is preferable that the pressure outside not fall below 0.05 to 0.1 bar, compared to a pressure of about 10⁻⁴ bar inside. It will also be noted that the bottles, even those with thin walls, can withstand this difference in pressure without undergoing significant deformation. For this reason, the design includes providing the cover with a control valve (not shown) that can close off the auxiliary termination.

The operation of the device just described can be as follows.

When the container has been loaded on the gripper cup 54, the cover is lowered into its closed position, and at the same time the injector is lowered through the main termination of the channel 64, but without blocking it.

When the cover is in the closed position, the air contained in the cavity 32, which cavity is connected to the vacuum system by the internal channel 64 of the cover 34, can be exhausted.

At first, the valve is opened so that the pressure drops in the cavity 32, both inside and outside the container. When the vacuum level outside the container has reached a sufficient level, the system closes the valve. The pumping can then continue exclusively inside the container 30.

When the treatment pressure is reached, the treatment can begin, according to the method of the invention.

According to the invention, the deposition method comprises a first step consisting of depositing directly on the substrate, in this instance on the inner surface of the bottle, an interface layer composed essentially of silicon, carbon, oxygen, nitrogen, and hydrogen. Obviously the interface layer will also be able to include other elements in small quantities or trace amounts, these other components originating from impurities contained in the reactive fluids used, or simply from impurities due to the presence of residual air present after completion of pumping.

To obtain such interface layer, a mixture comprising an organosilicon compound, that is, comprised essentially of carbon, silicon, oxygen and hydrogen, and a nitrogen compound are injected into the processing area.

The organosilicon compound, for example, can be an organosiloxane, and the nitrogen compound can simply be nitrogen. The use of an organosilazane containing at least one atom of nitrogen could also be considered for the organosilicon compound.

Organosiloxanes such as hexamethyldisiloxane (HMDSO) or tetramethyl-disiloxane (TMDSO) are generally liquid at ambient temperature. Also, in order to inject them into the processing area, a carrier gas can be used which is combined in a bubble tube with fumes from the organosiloxane, or simply work at the saturated vapor pressure of the organosiloxane.

If a carrier gas is used, it can be a rare gas such as helium or argon. Advantageously, however, nitrogen gas (N2) can simply be used as the carrier gas.

According to a preferred form of embodiment, this interface layer is obtained by injecting HMDSO into the processing area, in this instance the internal volume of a 500 ml plastic bottle at a flow rate of 4 sccm (standard cubit centimeters per minute), using nitrogen gas as the carrier gas at a flow rate of 40 sccm. The microwave power used, for example, is 400 W, and the processing time is on the order of 0.5 second. In this way, in a device of the type described above, an interface layer is obtained that has a thickness of only a few nanometers.

Various analyses have shown that the interface layer thus deposited contains silicon, of course, but it is particularly rich in carbon and nitrogen. It also contains oxygen and hydrogen. These analyses also show that there are numerous N—H type chemical bonds.

By way of example, a sample of an interface layer produced under the conditions described above contain about 12% silicon atoms, 35% carbon atoms, 30% oxygen atoms and 23% nitrogen atoms, not counting the hydrogen atoms that are not visible in the analysis method (ESCA) used for this quantification. For example, of the total number of atoms comprising the interface layer, the hydrogen atoms can represent 20%.

However, these data are only examples corresponding to specific parameters of the deposition method. It has been verified that, under conditions identical to the ones described above, the nitrogen flow rate can vary between 10 and 60 sccm with no significant change in the barrier properties of the coating thus obtained.

Tests have shown that it is possible, during this stage of deposition of the interface layer, to replace the nitrogen gas (N2) with air (at a flow rate of 40 sccm, for example) which is known to be composed of nearly 80% nitrogen.

On this interface layer, it is then possible to deposit a barrier layer of SiOx material. There are numerous techniques for depositing this type of material by low-pressure plasma. For example, 80 sccm of oxygen gas (O₂) could simply be added to the HMDSO/N2 mixture. This addition can be done either instantaneously or progressively.

The oxygen, usually in excess in the plasma, causes the nearly complete elimination of the carbon, nitrogen, and hydrogen atoms that are contributed either by the HMDSO or by the nitrogen used as the carrier gas. An SiOx material is thus obtained, in which x, which expresses the ratio of the quantity of oxygen to the quantity of silicon, is generally between 1.5 and 2.2 under the process conditions used. Under the conditions given above, a value of x of more than 2 can be obtained. Of course, as in the first step, impurities due to the method can be incorporated in small quantities in this layer without significantly changing the properties.

The duration of the second processing step can vary, for example, from 2 to 4 seconds. The thickness of the barrier layer thus obtained is therefore on the order of 6 to 20 nanometers.

The two steps of the deposition process can be performed as two completely separate steps, or as two linked steps without the plasma being terminated between them.

The barrier layer thus obtained is particularly heavy duty. Thus, a standard 500 ml PET bottle on which a coating according to the specifications of the invention has been deposited has a permeability rate of less than 0.002 cubic centimeter of oxygen entering into the bottle per day.

The interface layer, according to the invention, can be characterized by a relatively high nitrogen content, for example between 10 and 25% of the total number of atoms of the layer. The layer also contains a relatively high proportion of hydrogen atoms. The simultaneous presence of these two components in the interface layer makes it possible to obtain a coating which, in addition to good properties of adhesion to the substrate, has very good gas barrier properties, which is not the case, for example, when the interface layers are deposited without nitrogen.

This phenomenon is particularly remarkable because the interface layer according to the invention has itself practically no gas barrier properties, and in addition it does not have good characteristics of resistance to abrasion or chemical attack.

1. Method using a low pressure plasma to deposit a barrier coating on a substrate to be treated, of the type in which the plasma is obtained by partial ionization, under the action of an electromagnetic field, of a reactive fluid injected under low pressure into the treatment area,
characterized in that it comprises at least one step consisting of depositing on the substrate an interface layer obtained by converting to plasma a mixture that includes at least an organosilicon compound and a nitrogen compound, and a step consisting of depositing on the interface layer a barrier layer composed essentially of a silicon oxide with the formula SiOx.

2. Method according to claim 1, characterized in that the nitrogen compound is nitrogen gas.

3. Method according to either of claims 1 or 2, characterized in that the mixture used to deposit the interface layer also has a rare gas that is used as a carrier gas to cause the evaporation of the organosilicon compound.

4. Method according to claim 2, characterized in that the nitrogen is used as carrier gas to cause the evaporation of the organosilicon compound.

5. Method according to any of the preceding claims, characterized in that the thickness of the interface layer is between 2 and 10 nanometers.

6. Method according to any of the preceding claims, characterized in that the barrier layer is obtained by low-pressure plasma deposition of an organosilicon compound in the presence of an excess of oxygen.

7. Method according to any of the preceding claims, characterized in that the organosilicon compound is an organosiloxane.

8. Method according to any of the preceding claims, characterized in that the barrier layer has a thickness of between 8 and 20 nanometers.

9. Method according to any of the preceding claims, characterized in that the steps are continuously linked so that, in the processing area, the reactive fluid remains in the plasma state during the transition between the two steps.

10. Method according to any of the preceding claims, characterized in that the method includes a third step during which the barrier layer is covered with a protective layer of hydrogenated amorphous carbon.

11. Method according to claim 10, characterized in that the protective layer has a thickness of less than 10 nanometers.

12. Method according to claim 10, characterized in that the protective layer is obtained by low-pressure plasma deposition of a hydrocarbonated compound.

13. Method according to any of the preceding claims, characterized in that the substrate is composed of a polymer material.

14. Method according to claim 13, characterized in that the method is implemented to deposit a barrier coating on the inner face of a container made of polymer material.

15. Barrier coating deposited on a substrate by low pressure plasma, characterized in that it comprises a barrier layer, composed essentially of a silicon oxide with the formula SiOx, and in that, between the substrate and the barrier layer, the coating includes an interface layer that is composed essentially of silicon, carbon, oxygen, nitrogen, and hydrogen.

16. Coating according to claim 15, characterized in that the interface layer is obtained by converting to the plasma state a mixture comprising at least an organosilicon compound and a nitrogen compound.

17. Coating according to either of claims 15 or 16, characterized in that the nitrogen compound is nitrogen gas.

18. Coating according to any of claims 15 to 17, characterized in that the thickness of the interface layer is between 2 and 10 nanometers.

19. Coating according to any of claims 15 to 18, characterized in that the barrier layer is obtained by low-pressure plasma deposition of an organosilicon compound in the presence of an excess of oxygen.

20. Coating according to any of claims 15 to 19, characterized in that the organosilicon compound is an organosiloxane.

21. Coating according to any of claims 15 to 20, characterized in that the barrier layer has a thickness of between 8 and 20 nanometers.

22. Coating according to any of claims 15 to 21, characterized in that the barrier layer is covered with a protective layer of hydrogenated amorphous carbon.

23. Coating according to claim 22, characterized in that the barrier layer has a thickness of less than 10 nanometers.

24. Coating according to claim 22, characterized in that the barrier layer is obtained by low-pressure plasma deposition of a hydrocarbonated compound.

25. Coating according to any of claims 15 to 24, characterized in that it is deposited on a substrate made of a polymer material.

26. Container made of polymer material, characterized in that it is covered on at least one of its faces with a barrier coating in accordance with any of claims 15 to 25.

27. Container according to claim 26, characterized in that it is coated with a barrier coating on its inner face.

28. Container according to either of claims 26 or 27, characterized in that it can be a bottle made of polyethylene terephtalate.
